(19) United States
(12) Patent Application Publication
(10) Pub. No.: US 2015/0015897 A1
(43) Pub. Date: Jan. 15, 2015

(54) DYNAMOELECTRIC MACHINE COMPONENT MONITORING SYSTEM

(71) Applicant: General Electric Company, Schenectady, NY (US)

(72) Inventor: Hemanth Gudibande Sathya Kumar, Bangalore (IN)

(21) Appl. No.: 13/938,820

(22) Filed: Jul. 10, 2013

(51) Int. Cl. G01B 11/00

(52) U.S. Cl. CPC G01B 11/00
USPC 356/625

(57) ABSTRACT

Various embodiments include systems adapted to detect a target within a machine casing. In some embodiments systems include a target attached to a component within a dynamoelectric machine casing, a conduit spanning from an outer surface of the dynamoelectric machine casing to an inner surface of the dynamoelectric machine casing and an optical detection device external to the outer surface of the dynamoelectric machine casing and configured to detect the target attached to the component through the conduit.

### FIELD OF THE INVENTION

The subject matter disclosed herein relates generally to systems adapted to detect a target within a machine casing. More specifically, the disclosure provided herein relates to systems adapted to detect a target attached to a component within a dynamoelectric machine casing.

### BACKGROUND OF THE INVENTION

There is often a need for detection of component location within a machine. Components may grow due to thermal expansion and the growth of the components may lead to decreased performance of the machine. In particular, there is a need for detection and measurement of thermal growth of bearings within a dynamoelectric machine, for example, a turbine. In a turbine, thermal growth of a rotor bearing should be monitored, because such growth may affect the radial clearance of the rotor. Conventional systems attempt to predict rotor bearing position and position changes, e.g., due to thermal growth. Accurate predictions are desired in order to help in assuring proper clearances and alignment. Proper clearances and alignment lead to better performance, reduced vibration and reduced rubbing. Further, avoidance of rubs and lessening of vibrations may results in fewer machining reworks and less turbine downtime. In conventional systems, the amount of thermal growth is predicted and precise measurement is generally not possible.

### BRIEF DESCRIPTION OF THE INVENTION

Various embodiments include systems adapted to detect a target within a machine casing. In some embodiments systems include a target attached to a component within a dynamoelectric machine casing, a conduit spanning from an outer surface of the dynamoelectric machine casing to an inner surface of the dynamoelectric machine casing and an optical detection device external to the outer surface of the dynamoelectric machine casing and configured to detect the target attached to the component through the conduit.

According to a first aspect of the invention is a system comprising: a target attached to a component within a dynamoelectric machine casing; a conduit spanning from an outer surface of the dynamoelectric machine casing to an inner surface of the dynamoelectric machine casing; and an optical detection device external to the outer surface of the dynamoelectric machine casing and configured to detect the target attached to the component through the conduit.

A second aspect of the invention provides a system comprising: a target attached to a component within a dynamoelectric machine casing; a conduit spanning from an outer surface of the dynamoelectric machine casing to an inner surface of the dynamoelectric machine casing; an optical detection device external to the outer surface of the dynamoelectric machine casing and configured to detect the target attached to the component through the conduit, the optical detection device being configured to detect movement of the target, the movement of the target being at least partially caused by thermal expansion of the component during operation of the dynamoelectric machine; and a monitoring system coupled with the optical detection device, the monitoring system configured to perform the following: compare data indicating the position of the target with a threshold; and provide an alert in response to determining the data indicating the position of the target deviates from the threshold.

A third aspect of the invention provides a dynamoelectric machine system comprising: a target attached to a component within a dynamoelectric machine casing; a conduit spanning from an outer surface of the dynamoelectric machine casing to an inner surface of the dynamoelectric machine casing; and an optical detection device external to the outer surface of the dynamoelectric machine casing and configured to detect the target attached to the component through the conduit.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 illustrates a three-dimensional perspective view of a system according to embodiments of the invention.

FIG. 2 illustrates a three-dimensional perspective view of a system according to embodiments of the invention.

FIG. 3 FIG. 3 is a flow diagram illustrating processes which may be performed by monitoring system, according to aspects of the invention.

FIG. 4 illustrates a view of a conduit according to embodiments of the invention

FIG. 5 illustrates a view of a window according to embodiments of the invention.

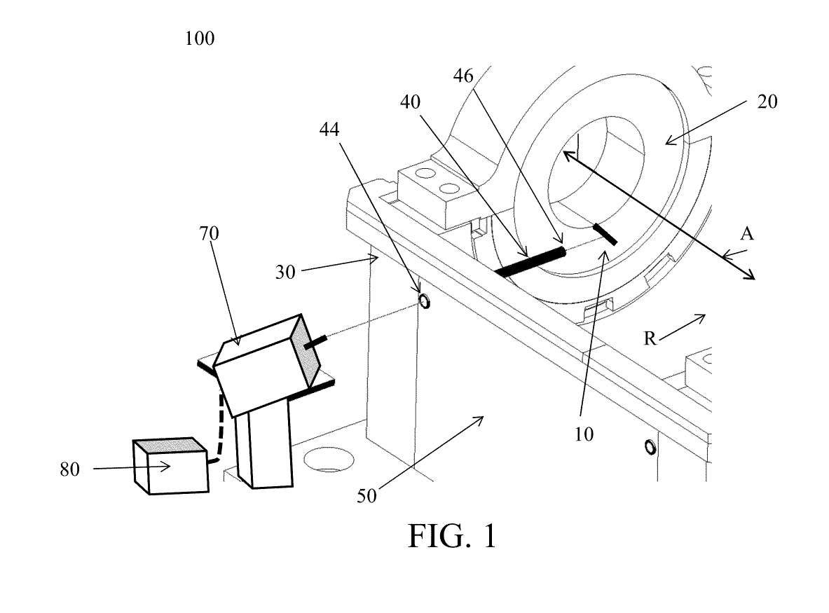

It is noted that the drawings of the invention are not necessarily to scale. The drawings are intended to depict only typical aspects of the invention, and therefore should not be considered as limiting the scope of the invention. It is understood that elements similarly numbered between the figures may be substantially similar as described with reference to one another. Further, in embodiments shown and described with reference to FIGS. 1-5, like numbering may represent like elements. Redundant explanation of these elements has been omitted for clarity. Finally, it is understood that the components of FIGS. 1-5 and their accompanying descriptions may be applied to any embodiment described herein.

### DETAILED DESCRIPTION OF THE INVENTION

The subject matter disclosed herein relates generally to systems adapted to detect a target within a machine casing. More specifically, the disclosure provided herein relates to systems adapted to detect a target attached to a component within a dynamoelectric machine casing.

As indicated herein, systems according to various aspects of the invention include an optical detector and target arrangement for the monitoring of components within a machine casing. Exemplary systems may be used to monitor rotor bearing growth at a bearing location in a turbomachine or other dynamoelectric machine. As described herein in dynamoelectric machines such as a turbine, detection of thermal growth of rotor bearings is desired, at least because thermal growth can affect radial clearance of the rotor.

As differentiated from current systems which predict thermal growth of components within dynamoelectric machines, aspect of the invention allow for precise measurements of differences in size and location of machine components, for example, differences due to thermal growth.

Various embodiments of the invention may facilitate measurement of absolute bearing growth from the foundation of a dynamoelectric machine. Accurate measurement of thermal growth of components may help in setting up better clearances and alignment of machine components, including rotors. Various embodiments of the invention allow for better alignment and proper component clearance, and such improvements may lead to better machine performance and fewer rubs. Improvements that allow for the avoidance of rubs and lessening of vibrations may result in less need to rework or rebuild the dynamoelectric machine and less machine downtime. Also, aspects of the invention also allow for more precise measurement of bearing stiffness which is an important aspect in rotor dynamics.

Turning to FIG. 1, a perspective drawing illustrating a three-dimensional perspective view of a system according to embodiments of the invention is shown. It should be understood that this perspective drawing illustrates a system with an upper machine casing section removed for clarity of illustration. In practice, the system will include a substantially symmetric upper machine casing section, which may be coupled with the lower machine casing section (illustrated), as is known in the art FIG. 1 illustrates a system 100 for detecting the position of a dynamoelectric machine component 20 within a machine casing 30. The system 100 includes an optical detection device 70 external to the outer surface 50 of the dynamoelectric machine casing 30. System 100 includes a target 10 attached to a component 20. The optical detection device 70 is configured to detect the target 10 attached to the component 20 through the conduit 40. According to aspects of the invention, the optical detection device 70 may be configured to detect movement of the target 10; the movement of the target 10 may be at least partially caused by thermal expansion of the component 20 during operation of the dynamoelectric machine. In cases where the component 20 is a rotor, the movement of the target 10 may be longitudinal movement in a direction of a major axis A of the rotor of the dynamoelectric machine, (rotor not shown).

The dynamoelectric machine used with system 100 may be a turbine and component 20 may be a rotor bearing. It is contemplated that system 100 may be used with machines other than dynamoelectric machines. Also, it should be noted that although only one target 10 is illustrated, it should be understood that the number of targets is not limited to one.

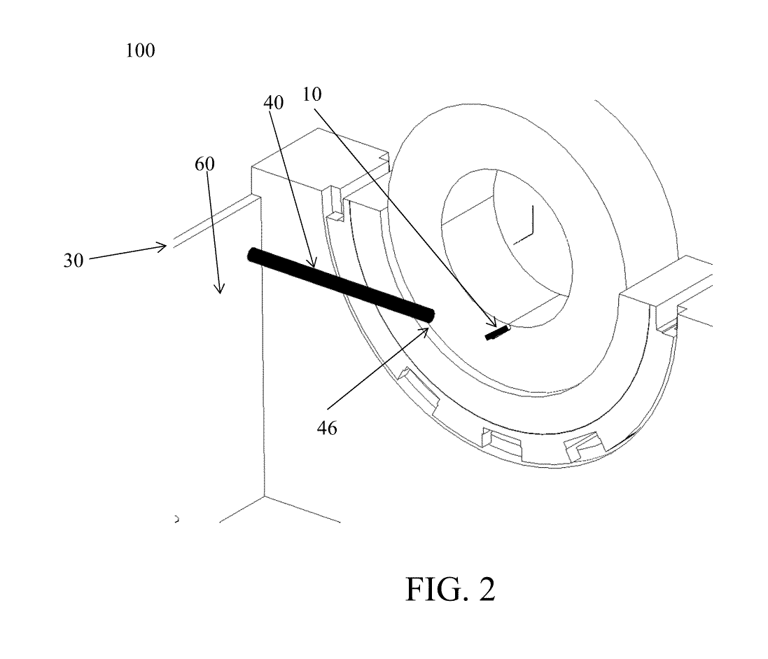

Conduit 40 is shown spanning from a dynamoelectric machine casing outer surface 50 to within a dynamoelectric machine casing inner surface 60 (inner surface 60 shown in FIG. 2). According to aspects, a conduit first end 44 may be on dynamoelectric machine casing outer surface 50. According to aspects of the invention, conduit second end 46 may be interior to or radially inboard R of the dynamoelectric machine casing 30 inner surface 60.

In some embodiments, optical detection device 70 is located external to the dynamoelectric machine casing outer surface 50 and may be located proximate the conduit first end 44, and target 10 may be proximate the conduit second end 46. While only one configuration of conduit 20 relative to machine casing 30 is illustrated, it should be understood that conduit first and second ends 44 and 46 may be located at inner and outer machine casing surfaces 50 and 60, or conduit first and second ends 44 and 46 may be located radially beyond (e.g., radially inboard R or radially outboard of) either or both of the inner and outer machine casing surfaces, 50 and 60.

Target 10 is illustrated as an appendage attached to and extending out from component 20; however target 10 is not limited to such a device. Target 10 may be embedded in component 20, or placed on a surface of component 20. It is contemplated that target 10 may be anything that may be detected by optical detection device 70. The material of target 10 is only limited in that it must be compatible with the interior of a dynamoelectric machine.

Optical detection device 70 may be any device capable of detecting target 10 via optical detection methods. According to aspects of the invention, optical detection device 70 may be a laser-based optical detection system, a digital camera or an analog camera. However, it is understood that the optical detection device 70 could take the form of other known optical detection systems in other embodiments. Monitoring system 80 is shown coupled with the optical detection device 70, e.g., via conventional wireless and/or hard-wired connection(s). The monitoring system 80 may include at least one computing device, computer program code, etc., and is described in more detail herein.

FIG. 2 illustrates a three-dimensional perspective view of system 100 according to embodiments of the invention. FIG. 2 illustrates parts of system 100 from inside machine casing 30 and shows machine casing inner surface 60, conduit second end 46 and target 10. As can be seen, conduit 40 is positioned to allow detection of target 10 by optical detection device 70 (optical detection device 70 shown in FIG. 1).

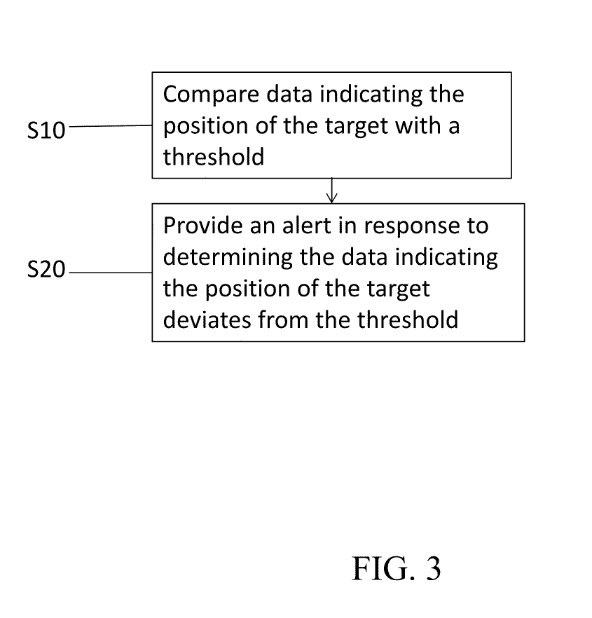

FIG. 3 is a flow diagram illustrating processes which may be performed by monitoring system 80, according to aspects of the invention. As stated above, monitoring system 80 may include at least one computing device and/or program code for executing one or more functions described herein according to various embodiments. It should be understood that monitoring system 80 may be implemented by one or more general-purpose computers, or on one or more specific-purpose computers, or any combination of such computing devices. Monitoring system 80 may be coupled to optical sensor 70 in order to monitor position and changes in position of target 10 (e.g., in some cases, instantaneous and/or semi-instantaneous changes), and it should be understood that there are many ways of coupling the monitoring system 80 with the optical detection device 70, e.g. wired and/or wirelessly. The monitoring system 80 may be installed proximate the optical detection system 70 (e.g., within the same or similar physical location), or installed remotely; further, it is understood that the monitoring system 80 may be physically integrated into the optical detection device 70 according to various embodiments. In these cases, the monitoring system 80 can be implemented in at least one computing device (e.g., including a processor, memory, input/output, etc.) that is physically housed within the optical detection device 70. Monitoring system 80 may be configured to receive information regarding the location of component 20 at one or more time(s), and monitoring system 80 may analyze instantaneous location values for the component 20 based upon the information about the location of the component 20, e.g., by comparing one or more pieces of data about the location of the component 20 with an expected, known, and/or calculated location of the component 20. Further, monitoring system 80 may store location information for component 20 and compile such data for trending and/or comparative purposes. According to aspects of the invention, monitoring system 80 may be configured to compare data indicating the position of the target 10 with a threshold, as described with reference to process S10. Monitoring system 80 may be further configured to provide an alert in response to determining the data indicating the position of the target deviates from the threshold, as described with reference to process S20. Such a threshold may be determined based on operating parameters of the dynamoelectric machine, e.g., in order to reduce the likelihood of misalignment or rubs.

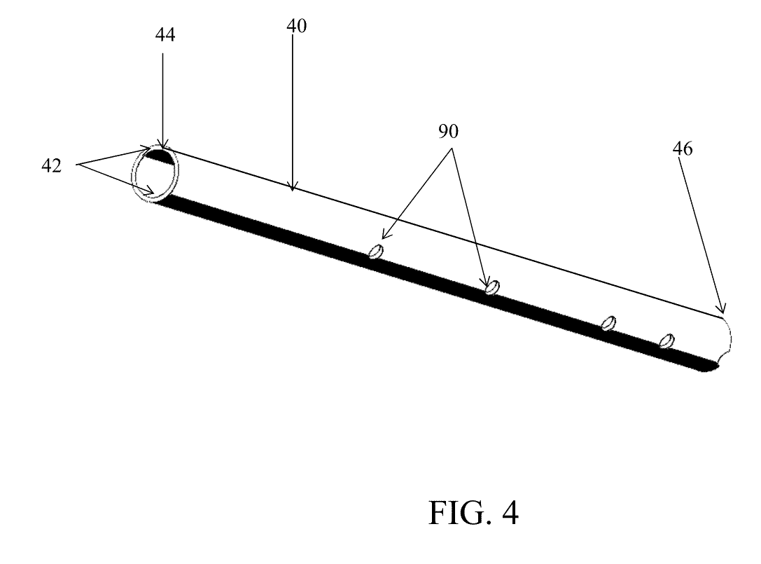

FIG. 4 illustrates a view of a conduit 40 according to various embodiments of the invention. As dynamoelectric machines may have oil vapor or other types of vapors within their casing during machine operation, conduit 40 may include at least one drainage hole 90 to allow drainage of vapor or fluid that may enter conduit 40. Drainage may be a result of gravity, and while FIG. 4 appears to have drainage holes 90 positioned on a side of conduit 40, the placement of drainage holes 90 maybe at the lowest surface of the conduit 40. The position of the drainage holes 90 can allow drainage of fluid that may enter conduit 40. Also, conduit 40 may be sloped so that conduit second end 46 is lower than conduit first end 44 to assist with drainage. Other configurations are possible, including where conduit 40 has no slope, or where conduit 40 slopes upward toward target 10, with a drainage hole 90 properly placed to facilitate drainage of liquid or other material that enters conduit 40. Conduit 40 may include a substantially radially congruous passageway 42 which may provide an optically unobstructed sightline or a substantially unobstructed sightline between the outer surface and the inner surface 50 and 60, respectively of the machine casing 30 (outer and inner surfaces 50 and 60 shown in FIGS. 1 and 2, respectively).

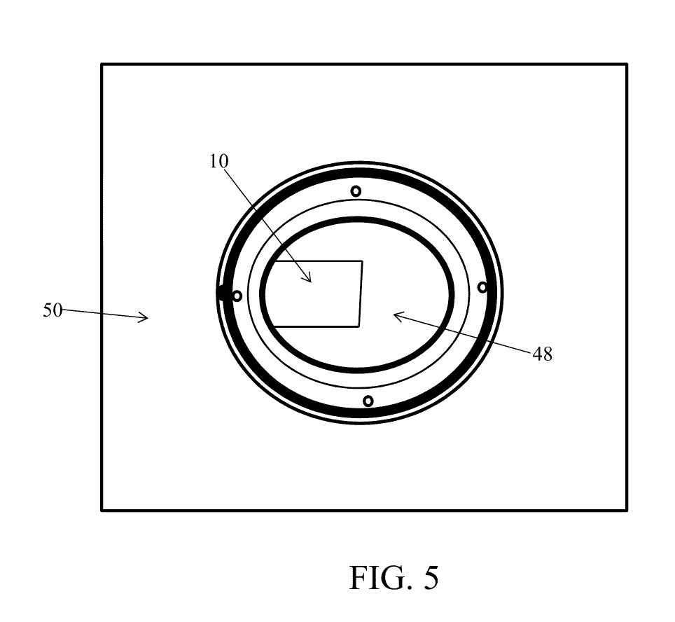

FIG. 5 illustrates a window 48 according to aspects of the invention. The window 48 may be located within the conduit 40, including at a location at the machine casing outer surface 50, and the window 48 may be proximate the optical detection device 70. Window 48 can allow detection device 70 (not shown in FIG. 5) to detect target 10, and window 48 may be transparent or substantially transparent according to different aspects of the invention. Window 48 may include glass, tempered glass or any material that is transparent or substantially transparent and which is compatible with use in conjunction with a dynamoelectric machine.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the terms “axial” and/or “axially” refer to the relative position/direction of objects along axis A, which is substantially parallel with the major axis of a turbomachine rotor in cases where the dynamoelectric machine includes a turbomachine rotor. As further used herein, the terms “radial” and/or “radially” refer to the relative position/direction of objects along radius (R), which is substantially perpendicular with axis A and intersects axis A at only one location. Additionally, the terms “circumferential” and/or “circumferentially” refer to the relative position/direction of objects along a circumference which surrounds axis A but does not intersect the axis A at any location. The terms “first” and “second” are not meant to designation any type of order; rather they are used to differentiate two distinct entities, and may be interchanged.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a target attached to a component within a dynamoelectric machine casing;
a conduit spanning from an outer surface of the dynamoelectric machine casing to an inner surface of the dynamoelectric machine casing; and
an optical detection device external to the outer surface of the dynamoelectric machine casing and configured to detect the target attached to the component through the conduit.

2. The system of claim 1, wherein the conduit includes a substantially transparent window.

3. The system of claim 1, wherein the conduit includes:
a first end on the outer surface of the dynamoelectric machine casing; and
a second end being proximate to or radially inboard of the surface of the dynamoelectric machine casing,
wherein the optical detection device is located proximate the first end, and the target is proximate the second end.

4. The system of claim 1, wherein the conduit includes at least one drainage hole.

5. The system of claim 1, wherein the optical detection device includes a laser-based optical detection device.

6. The system of claim 1, wherein the component includes a rotor bearing of the dynamoelectric machine.

7. The system of claim 1, wherein the conduit includes a substantially radially congruous passageway.

8. The system of claim 7, wherein the substantially radially congruous passageway provides an optically unobstructed sightline between the outer surface and the inner surface.

9. The system of claim 1, wherein the optical detection device is configured to detect movement of the target.

10. The system of claim 9, wherein the movement of the target is at least partially caused by thermal expansion of the component during operation of the dynamoelectric machine.

11. The system of claim 9, wherein the movement of the target is longitudinal movement in a direction of a major axis of a rotor of the dynamoelectric machine.

12. The system of claim 1, further comprising a monitoring system coupled with the optical detection device, the monitoring system configured to perform the following:
compare data indicating the position of the target with a threshold; and
provide an alert in response to determining the data indicating the position of the target deviates from the threshold.

13. A system comprising:
a target attached to a component within a dynamoelectric machine casing;
a conduit spanning from an outer surface of the dynamoelectric machine casing to an inner surface of the dynamoelectric machine casing;
an optical detection device external to the outer surface of the dynamoelectric machine casing and configured to detect the target attached to the component through the conduit, the optical detection device being configured to detect movement of the target, the movement of the target being at least partially caused by thermal expansion of the component during operation of the dynamoelectric machine; and
a monitoring system coupled with the optical detection device, the monitoring system configured to perform the following:
compare data indicating the position of the target with a threshold; and
provide an alert in response to determining the data indicating the position of the target deviates from the threshold.

14. The system of claim 13, wherein the conduit includes a substantially transparent window.

15. The system of claim 13, wherein the conduit includes:
a first end on the outer surface of the dynamoelectric machine casing; and
a second end being proximate to or radially inboard of the surface of the dynamoelectric machine casing,
wherein the optical detection device is located proximate the first end, and the target is proximate the second end.

16. The system of claim 13, wherein the conduit includes at least one drainage hole.

17. The system of claim 13, wherein the optical detection device includes a laser-based optical detection device.

18. The system of claim 13, wherein the component includes a rotor bearing of the dynamoelectric machine.

19. A dynamoelectric machine system comprising:
a target attached to a component within a dynamoelectric machine casing;
a conduit spanning from an outer surface of the dynamoelectric machine casing to an inner surface of the dynamoelectric machine casing; and
an optical detection device external to the outer surface of the dynamoelectric machine casing and configured to detect the target attached to the component through the conduit.

20. The dynamoelectric machine system of claim 19, further comprising:
a monitoring system coupled with the optical detection device, the monitoring system configured to perform the following:
compare data indicating the position of the target with a threshold; and
provide an alert in response to determining the data indicating the position of the target deviates from the threshold.
